(19) United States
(12) Patent Application Publication
(10) Pub. No.: US 2026/0104351 A1
(43) Pub. Date: Apr. 16, 2026

(54) DEVICE AND METHOD FOR MEASURING PROPERTY OF A FLUID

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR); UNIVERSITÉ PARIS CITÉ, Paris (FR)

(72) Inventors: Guillaume JOURDAN, Grenoble Cedex 09 (FR); Hamidreza NESHATEH, Paris (FR); Ivan FAVERO, Paris (FR)

(73) Assignees: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR); UNIVERSITÉ PARIS CITÉ, Paris (FR)

(21) Appl. No.: 19/358,786

(22) Filed: Oct. 15, 2025

(30) Foreign Application Priority Data
Oct. 16, 2024 (FR) FR2411242

(51) Int. Cl. G01N 21/17

(52) U.S. Cl. CPC G01N 21/1702; G01N 2201/0231; G01N 2201/08

(57) ABSTRACT

A device for measuring at least one property of a fluid, including a cell (1) adapted to receive a volume of fluid, an optical waveguide (2) including an input port (20) adapted to be coupled to a light source (3) so as to transmit an optical signal (L) emitted by the light source, an optomechanical resonator (7) arranged in the cell (1) so as to have at least one main surface in contact with the fluid, the resonator including a suspended element (70) arranged in the vicinity of the optical waveguide (2) so as to allow evanescent coupling between the optical waveguide (2) and the suspended element (70), a measuring unit (5) arranged at an output port (21) of the optical waveguide (2) for receiving the output optical signal, and a processing unit coupled to the measuring unit.

### TECHNICAL FIELD

The invention relates to a device for measuring properties of a fluid, as well as a measuring method implemented by means of said device.

### STATE OF THE ART

There are different techniques for characterizing a fluid, based on different properties and different measurement means.

For example, in the laboratory there are different types of viscometers or rheometers to measure the viscosity of a fluid. However, each apparatus is optimized for a specific type of fluid, so it may be necessary to have different apparatuses to cover a wide range of fluids.

Moreover, these devices only measure viscosity and other devices must therefore be used if other properties of the fluid, such as its density, refractive index or thermal conductivity, are to be determined.

Finally, laboratory viscometers and rheometers are designed to receive samples of a relatively large volume.

However, in the field of diagnostics, significant needs are associated with “point of care” type tests, that is to say tests carried out close to the patient. These tests must be able to be implemented by personnel not necessarily trained in laboratory medicine and therefore require compact and easy-to-use devices.

Laboratory apparatuses are not suitable for this type of use.

There is therefore a need for a measurement device suitable for small fluid samples and capable of determining different properties of the latter.

### SUMMARY OF THE INVENTION

The invention aims at overcoming the aforementioned problems and to propose a measurement device capable of analyzing samples on the scale of a few microliters with great precision while being able to determine several different properties of the fluid.

To this end, a first object of the invention is a device for measuring properties of a fluid, comprising:
a cell adapted to receive a volume of fluid,
an optical waveguide comprising an input port adapted to be coupled to a light source so as to transmit an optical signal emitted by the light source,
an optomechanical resonator arranged in the cell so as to have at least one main surface in contact with the fluid, the resonator comprising a suspended element arranged in the vicinity of the optical waveguide so as to allow evanescent coupling between the optical waveguide and the suspended element,
a measuring unit arranged at an output port of the optical waveguide for receiving the output optical signal, comprising:
a first detection unit configured to measure a low frequency component of the output signal, and
a second detection unit for measuring a radiofrequency component of the output signal, and
a processing unit coupled to the measuring unit and configured to:
from the measurement data of the first detection unit, determine a first property among a refractive index and a thermal conductivity of the fluid, and
from the measurement data of the second detection unit, determine a second property among a viscosity, a density and a compressibility of the fluid.

According to other advantageous characteristics of the invention, taken independently or combined when technically possible:
the suspended element is a disc or a ring secured to a substrate defining one face of the cell by a central foot;
the suspended element has an oblong shape and is secured to a substrate defining one face of the cell by two feet;
the suspended element is a nanostructured beam secured by its two ends to a substrate defining two faces of the cell;
the suspended element is made of an optomechanical crystal, in particular silicon;
the cell has a volume of less than 1 microliter, preferably less than 1 nanoliter;
the cell has at least one dimension less than 1 mm, preferably less than 200 μm;
the cell is closed;
the cell is a microfluidic channel extending between a fluid inlet and outlet;
the device further comprises at least one actuation device adapted to vibrate the suspended element;
the device further comprises means (e.g. a heater) for controlling the temperature of the fluid in the cell.

Another object of the invention is a method for measuring at least one property of a fluid by means of the device described above. Said method comprises:
placing the fluid in the cell of said device,
transmitting an optical signal emitted by the light source by the optical waveguide,
exciting at least one optical mode of the optomechanical resonator by the evanescent coupling of the suspended element and the optical waveguide,
oscillating the suspended element according to at least one mechanical resonance mode, said oscillation affecting the signal transmitted by the optical waveguide by the evanescent coupling,
measuring, by the first detection unit, a low-frequency component of the output signal,
measuring, by the second detection unit, a radiofrequency component of the output signal,
from the measurement data of the first detection unit, determining a first property among a refractive index and a thermal conductivity of the fluid,
from the measurement data of the second detection unit, determining a second property among a viscosity, a density and a compressibility of the fluid.

According to other advantageous characteristics of the invention, taken alone or in combination when technically possible:
the fluid is static in the cell;
the fluid is flowing in the microfluidic channel;
the method comprises a power sweep of the light source;
the method comprises a wavelength sweep of the light source;
the actuation device is activated to vibrate the suspended element, and the detection unit measures a resonance frequency of the suspended element;
the suspended element is activated in vibration by the thermomechanical noise generated by the molecules of the fluid, and the detection device measures a resonance frequency of the suspended element;
the method comprises simultaneously transmitting, by the optical waveguide, two light beams of different wavelengths, each wavelength being associated with the measurement of a low frequency, respectively radio frequency component, of the output signal, and simultaneously measuring said components by the first and second detection units.

### BRIEF DESCRIPTION OF THE FIGURES

Other characteristics and advantages of the invention will emerge from the detailed description which follows, with reference to the appended drawings, in which:

FIG. 1 is a schematic diagram of the measurement device;

FIG. 2 is a diagram of the waveguide and the optomechanical resonator;

FIG. 3 is a partial view of the waveguide and the optomechanical resonator allowing evanescent coupling of the light circulating in the waveguide;

FIG. 4A, FIG. 4B, FIG. 4C, FIG. 4D and FIG. 4E illustrate different embodiments of the optomechanical resonator;

FIG. 5 is a scanning electron microscope image of an electrostatic actuation device of the optomechanical resonator;

FIG. 6 is a flowchart showing the measurement protocol;

FIG. 7 is an example of thermo-optical response of an optomechanical resonator according to one embodiment of the invention; the figure gives the optical transmission rate as a function of the wavelength for increasing input power.

For reasons of readability of the figures, the various elements are not necessarily drawn to scale. Identical elements or those fulfilling the same function are designated from one figure to another by the same reference symbol and are not described in detail each time.

### DETAILED DESCRIPTION OF EMBODIMENTS

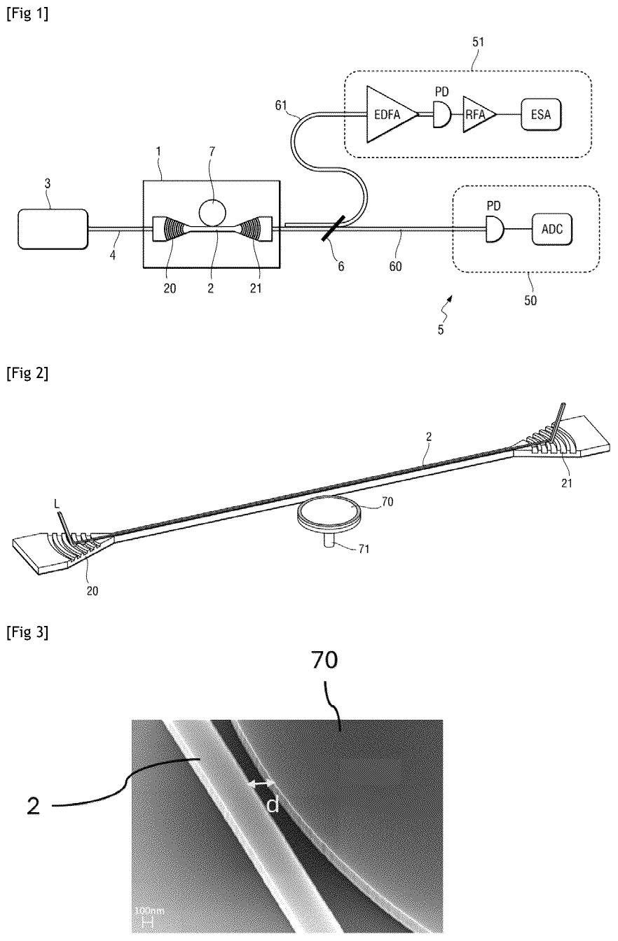

FIG. 1 is a block diagram of the measurement device according to the invention.

The device comprises a cell 1 intended to receive a fluid sample. Preferably, the cell is of the microfluidic type, that is to say that the cell has at least one dimension less than 1 mm, preferably less than 200 μm. Advantageously, the internal volume of the cell is less than 1 microliter, preferably less than 1 nanoliter. However, for certain applications, the device can be used with a larger volume of fluid.

In some embodiments, the cell is closed, with the sample being static in the cell. The sample may be introduced into the cell using an external device, for example, a syringe.

In other embodiments, the cell is in the form of a channel through which the sample flows. The channel extends between a sample inlet and a sample outlet. Movement of the sample between the inlet and outlet may be caused, for example, by a pump or other suitable device.

The fluid can be a liquid or a gas.

Liquids of interest include biological fluids, in particular blood plasma, but also polymers, inks, or electrolytes used in batteries. The fluid may consist of a material that is in a liquid state during measurement but subsequently solidifies.

Gases of interest include hydrocarbon gases, such as methane.

The cell is advantageously formed in or on a chip. The cell walls may in particular be etched into a silicon substrate or another substrate used in microelectronics or biology, such as a polymer or ceramic.

The cell may comprise means (not shown) for controlling the temperature of the fluid, e.g. a heater, to maintain the fluid at a determined temperature and/or vary the temperature of the fluid in a controlled manner. These means may be in the form, for example, of a Peltier element arranged in contact with one face of the cell. In a complementary or alternative manner, these means may be in the form of a micro heater which is similar to an electrical resistor whose dimension is from a few tens to a few hundreds of micrometers. Such micro heaters are commonly used in the field of silicon photonics. Finally, as mentioned below, the fluid can be locally heated via the optomechanical resonator arranged in the cell, by injecting an optical beam of adapted power into it.

The device further comprises an optical waveguide 2 extending between an input port 20 and an output port 21. The input port of the optical waveguide is coupled to a light source 3, such as a laser, allowing to inject an optical signal into the optical waveguide.

The connection between the light source and the waveguide can be made by an optical fiber 4 or any other suitable optical connection means.

The output port of the waveguide is coupled to a measuring unit 5 which will be described in detail below. The connection between the waveguide and the measuring unit can be made by an optical fiber 60, 61 or any other suitable optical connection means.

The device comprises an optomechanical resonator arranged in the cell so that at least one of its main faces is in contact with the fluid. By optomechanical resonator, it is understood that the resonator has at least one optical mode, that is to say a mode of confinement of an incident light beam, and one mechanical mode, that is to say a mode of vibration in a resonance state. The confinement of a light beam may typically be achieved at a refractive index gradient in the resonator. Such a difference in refractive index can be obtained by the use of two different materials within the resonator (for example an alternation of silicon regions and silicon nitride regions), by imposing a difference in impurity concentration between two regions of the resonator (for example in the case of silicon oxide), or at the interface between the resonator and another medium, for example the ambient fluid. The geometry and material of the optomechanical resonator can thus be chosen to obtain the desired optical and mechanical modes.

Particularly advantageously, the optomechanical resonator is of micrometric dimension, that is to say that it is capable of being inserted into a microfluidic cell. Thus, the optomechanical resonator has at least one dimension less than 1 mm, preferably less than 100 μm.

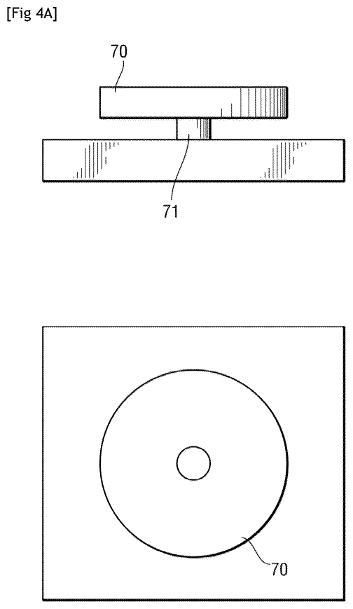

FIG. 2 is a perspective diagram of the waveguide and optomechanical resonator. The cell walls and light source are not shown in this diagram.

The waveguide 2 comprises an elongated main body of rectangular section. The input port 20 has a flared shape which narrows towards the junction with the main body; conversely, the output port 21 has a flared shape which widens from the junction with the main body. The input port and the output port have diffraction gratings (or “grating couplers”) whose function is to couple the incident, respectively outgoing optical beam L, out of the plane of the waveguide, with the waveguide extending in a plane. In practice, the optical fibers bringing and recovering the optical beam are positioned with a quasi-normal incidence relative to the optical waveguide.

The light source (laser) is advantageously tunable in a determined wavelength range. For example, for a waveguide made of AsGa, the wavelengths are greater than 900 nm. When the waveguide is made of silicon, the wavelengths in which the device works are comprised between 1100 and 2000 nm and can possibly go up to 7000 nm. The wide range of possible wavelengths allows to design devices adapted to the fluid to be studied. Indeed, it is possible to select a wavelength which is in a transparency window of the fluid; on the contrary, it may be interesting to operate near an absorption wavelength of the fluid, in order to provide a means for localized heating or to obtain a spectral signature of the fluid.

In practice, the device advantageously has a wide operating range (optical resonances can extend over a large wavelength range greater than a few hundred nm), which is mainly limited by diffraction gratings which have a bandwidth of 20-30 nm, for example between 1540 nm and 1570 nm.

The optical waveguide is arranged at least partially inside the cell in the vicinity of the optomechanical resonator. Preferably, the input and output ports of the optical waveguide are arranged outside the cell, the optical waveguide passing through the cell wall in a fluid-tight manner. Alternatively, the optical waveguide may be arranged entirely within the cell.

The optomechanical resonator 7 comprises a suspended element 70 (in this illustration, in the shape of a disc) and a central foot 71 connecting the suspended element to a support not shown. The support is for example the bottom of the cell, which is parallel to the plane in which the suspended element extends, the central foot extending from the lower face of the suspended element. In other embodiments, the central foot may extend from the upper face of the suspended element, or from both the lower face and the upper face of the suspended element.

In some embodiments, the resonator is immersed in the fluid, such that the two opposing major faces of the suspended element are in contact with the fluid. In other embodiments, only one major face of the suspended element is in contact with the fluid.

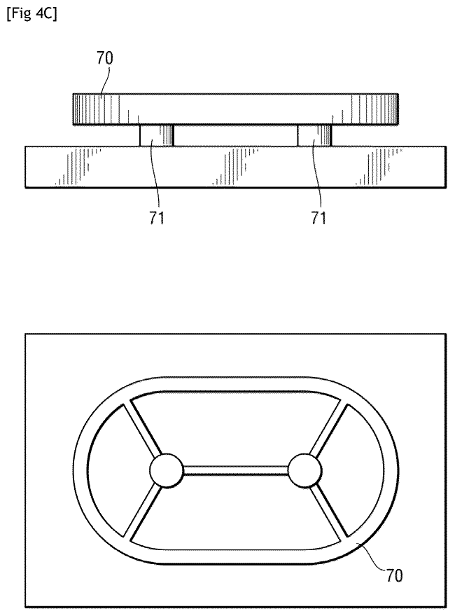

The central foot may be solid or hollow. In some embodiments (see FIG. 4E), a fluid channel 72 is arranged in the central foot 71 and passes through the suspended element 70, which allows to contact the fluid with the face of the suspended element opposite the central foot. In FIG. 4E, the face in contact with the fluid is the lower face of the suspended element.

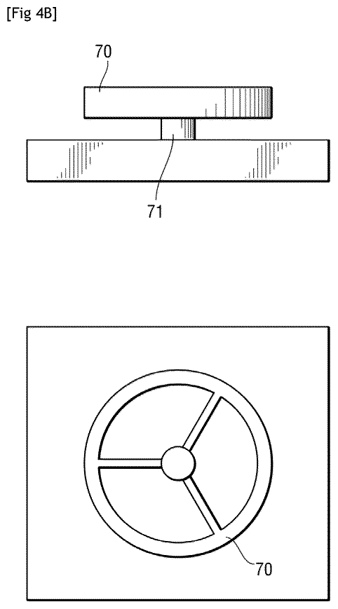

In the embodiment illustrated in FIG. 3, the suspended element 70 extends in the same plane as the optical waveguide 2. The suspended element 70 therefore has at least one main face coplanar with a main face of the optical waveguide. Main face, means a face of the suspended element having the largest surface.

To simplify the manufacture of the suspended element and the optical waveguide, the suspended element and the optical waveguide advantageously have the same thickness, their two main faces being coplanar. However, in other embodiments, the suspended element may be thicker or thinner than the optical waveguide.

Alternatively, the optical waveguide does not extend in the same plane as the suspended element but may be arranged above or below the suspended element, parallel thereto.

In all cases, the suspended element 70 is arranged at a distance d from the optical waveguide 2 which is chosen to be sufficiently small to allow evanescent coupling of the light between the optical waveguide and the suspended element. The distance d may depend on the wavelength of the optical signal. Generally speaking, the distance d, which is measured between the closest points of the optical waveguide and the suspended element, is of the order of 100 to 200 nm in the infrared range (that is to say around 1500 nm).

As is known per se, evanescent coupling is based on the existence of an evanescent wave, which is a wave whose amplitude decreases exponentially with the distance from the optical waveguide, and which is generated by the passage of the optical signal in the optical waveguide. An optical mode of the suspended element present in the evanescent field is therefore excited by the optical signal circulating through the optical waveguide. Conversely, a photon of the optical mode of the suspended element can penetrate into the optical waveguide and modify the beam collected at the output port of the optical waveguide.

For this purpose, the suspended element and the optical waveguide are made of a material that is substantially transparent to an optical signal in the wavelength range emitted by the light source.

Silicon is a particularly advantageous material due to its optical refractive index in the considered wavelength range and its mechanical properties. Furthermore, it can be etched using techniques well mastered in the field of microelectronics. However, other materials can be used as a substitute for silicon, for example gallium arsenide (AsGa) or silicon nitride (SiN).

The evanescent coupling can be optimized by adjusting in particular the width of the optical waveguide and/or the shape of the optical waveguide in the coupling zone to maximize the length of the guide which is arranged at the distance d from the suspended element. For example, in the case where the suspended element is rounded, the optical waveguide can have a rounded portion parallel to the suspended element to increase the evanescent coupling effect.

The suspended element is capable of being oscillated by optical, thermal and/or electrostatic means. The oscillation occurs in the plane of the main surface of the suspended element. Conversely, an oscillation of the suspended element in the plane of its main surface modifies the optical signal transmitted by the optical waveguide and imprints its movement in the amplitude and/or phase of the output optical beam.

The behavior of the suspended element depends on the fluid with which it is in contact.

The actuation can be generated deterministically (for example caused by an external actuation) or randomly (for example caused by thermomechanical noise generated by the collision of fluid molecules on the suspended element).

For optical actuation means, the excitation may result from an intensity-modulated optical field present in the suspended element, originating from the evanescent coupling with the optical waveguide.

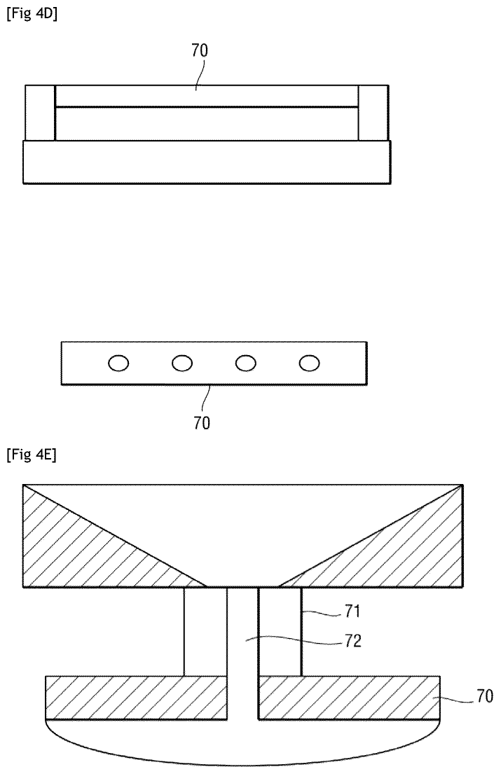

With reference to FIG. 5, the device may comprise electrostatic actuation means for the suspended element. This actuation means comprises an electrode 8 arranged in the plane of the suspended element. The application of a potential difference between the suspended element and the electrode generates a capacitive force which deforms the suspended element 70 (which has an annular shape in the illustrated embodiment).

FIGS. 4A to 4E illustrate, in side view and in top view, different embodiments of the optomechanical resonator.

In some embodiments, the suspended element has a circular shape (disc or ring) and is connected to the support by a central foot.

FIG. 4A thus illustrates a suspended element 70 having a disc shape and a central foot of circular section. The diameter of the disc is typically of the order of 2 to 60 μm, preferably of the order of 20 μm. The diameter of the central foot is typically of the order of 500 nm to 10 μm, preferably of the order of 1 μm.

FIG. 4B illustrates a suspended element 70 having a ring shape and a central foot connected to the ring by radial bridges.

In other embodiments, as illustrated in FIG. 4C, the suspended element 70 has an oblong shape, consisting of two circular arcs connected by rectilinear segments, and is connected to the support by two feet 71 arranged at the center of each respective circular arc.

In other embodiments, the suspended element is in the form of a nanostructured beam embedded at its two ends in the support, as illustrated in FIG. 4D. The nanostructuring is chosen to allow the generation of localized optical and mechanical vibration modes within the beam. Such nanostructuring comprises, for example, oval patterns connected or not by rectangular patterns. The length of the beam is typically of the order of 5 to 100 μm, the thickness of the beam is of the order of 100 to 500 nm and the width of the beam is of the order of 100 nm to 1 μm.

FIG. 4E illustrates another embodiment in which the suspended element is in the shape of a disc, but the disc and the central foot are crossed from one side to the other by a microfluidic channel. This embodiment is particularly advantageous when only one face of the suspended element must be in contact with the fluid. In this case, the microfluidic channel 72 allows to inject the fluid sample through the disc 70 to bring it into contact with the face opposite the central foot 71.

Returning to FIG. 1, the measuring unit 5 comprises two detection units.

A first detection unit 50 allows to measure a low-frequency component of the output signal.

A second detection unit 51 allows to measure a radiofrequency component of the output signal.

For this purpose, the output signal of the optical waveguide is separated by a symmetrical or asymmetrical beam splitter 6. A first part of the signal is conducted to the first detection unit 50 by an optical fiber 60 for an analysis of the low-frequency component of the signal and the other part of the optical signal is conducted to the second detection unit 51 by an optical fiber 61 for an analysis of the radiofrequency component of the signal.

The first detection unit 50 comprises a photodetector PD and an analog-to-digital converter ADC arranged at the output port of the photodetector.

The second detection unit 51 successively comprises an optical amplifier EDFA, a photodetector PD, a radiofrequency amplifier RFA and a spectral analyzer ESA.

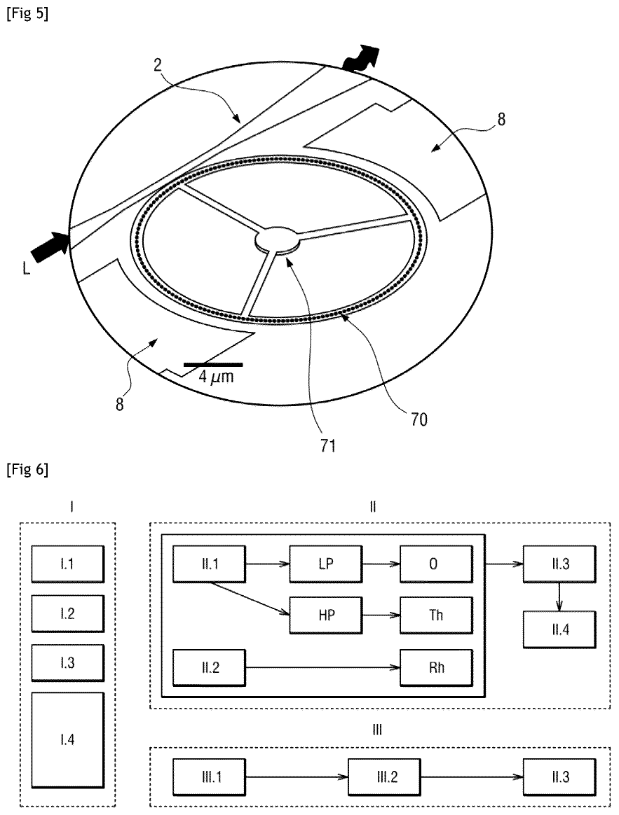

FIG. 6 is a flowchart showing the operation of the measurement device.

A first phase I prior to the measurement aims at setting up and stabilizing the operating conditions: ambient temperature (I.1), optical transmission (I.2), fluid level in the microfluidic cell (I.3). Moreover, models of the optical, thermal and mechanical response of the optomechanical resonator in contact with different fluids are recorded (I.4).

A second data collection phase II is implemented using the measuring unit.

A first part of the optical signal is directed by the beam splitter towards the first detection unit which records (II.1) the low-frequency component of the optical signal. This allows to measure, for a low optical power (LP) of the light source (typically less than 10 μW), the purely optical response O of the resonator in its linear regime. This response allows to determine the refractive index of the fluid. When the optical power is increased (HP typically, up to 200 μW or beyond), the response Th of the resonator is modified by a thermo-optical effect and allows to measure the thermal conductivity of the fluid by evaluating the heat dissipation within the fluid.

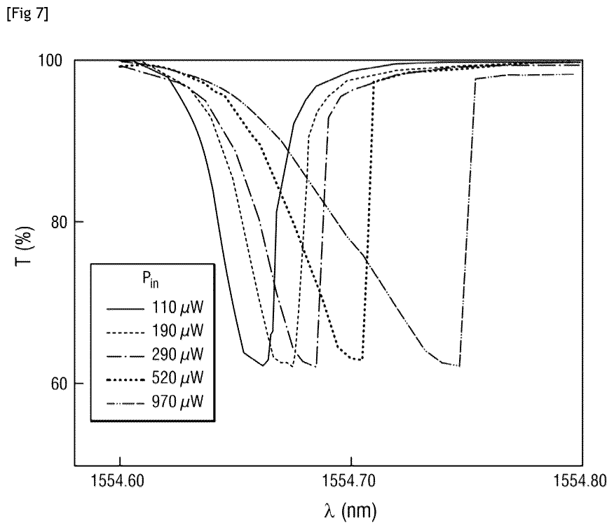

FIG. 7 illustrates this thermo-optical effect on the transmission curve T (in %) as a function of the wavelength λ (in nm) when the fluid is water. As the optical power Pin increases between 110 μW and 970 μW, the transmission minimum (and the optical resonance wavelength) is observed to shift towards higher wavelengths. At low power, the heating of the structure has a negligible impact on the resonance wavelength and the cell response resembles a Lorentzian curve. For higher powers, the heating of the cell modifies the resonance wavelength. The amount of light entering the cavity increases with the resonance wavelength, which shifts to the right as the wavelength is swept to the right as well. The thermo-optical response is also characterized by the existence of a hysteresis loop of the wavelength response when sweeping the wavelength downwards (not shown in this figure).

In parallel, the second part of the output signal from the optical waveguide is directed by the beam splitter to the second detection unit capable of measuring the RF component (II.2). This allows to measure the mechanical response of the resonator and to deduce the viscosity, compressibility and density of the fluid.

All of these measurements are performed very quickly, typically in a few seconds.

The measurements are first carried out on a reference fluid (II.3) then, once the device is calibrated, on the fluid of interest (II.4).

When using a single beam of light, the low-frequency measurement and the RF measurement are performed successively. Since each of these measurements is very fast, this does not affect the performance of the device.

Moreover, it is possible to perform the low-frequency measurement and the radio-frequency measurement simultaneously, for example, by using optical multiplexing to inject two light beams with different wavelengths into the optical waveguide. Each beam implements a different optical mode of the suspended element and is associated with the measurement of the low-frequency, respectively radio-frequency component. At the output port of the optical waveguide, optical demultiplexing can optionally be used to separate the two wavelengths upstream of the photodiodes.

Another use case for two light beams involves injecting optical power into the suspended element so as to heat it and thus heat the surrounding fluid. This configuration can allow the fluid to be heated very locally, particularly in the case of a microfluidic cell of micrometric dimension. This optical heating method can be implemented by using a second laser, called a pump laser, whose beam is superimposed in the optical waveguide on that of the measuring laser. Filtering (or demultiplexing) means are used to separate the optical signals at the output port of the optical waveguide if necessary.

Finally, a third post-processing phase III is implemented. This post-processing aims at comparing the models with the measurements carried out previously with a known fluid (typically water, or a mixture of water and glycerol at different concentrations) (III.1), at updating these models (III.2) and at using the models thus calibrated to determine the refractive index, thermal conductivity, density, viscosity and compressibility of the fluid of interest (III.3).

The frequency response of an oscillating disc can be modeled by the following system of formulas:

$$\dot{α} + [ \frac{κ}{2} + j [ Δ + {g}_{om} x + \frac{{ω}_{e}}{{n}_{eff}} \frac{{dn}_{eff}}{dT} Δ T ] ] a = \sqrt{{κ}_{ex} {P}_{bus}} \qquad ( 1 )$$

$$k {∇}^{2} T ( r ) + Q ( r ) = 0 \qquad ( 2 )$$

$${m}_{r} \ddot{x} + γ \dot{x} + {ω}_{s}^{2} x = ξ \qquad ( 3 )$$

Equation (1) governs the evolution of the optical field in the cell.

Equation (2) governs the heat propagation depending on the thermal conductivity k.

Equation (3) is the modified equation of movement of the optomechanical resonator.
a is the optical field in the cell,
P_{bus} is the incident optical power in the optical waveguide,
κ is the decay of the optical mode, equal to κ_{abs}+κ_{rad}+κₑₓ Where κ_{abs}, κ_{rad}, κₑₓ are the absorption, diffusion and exchange loss rates respectively,
Δ=ω_{L}-ω_{C} is the detuning between the laser and the cell,
x is the position of the suspended element,
gₒₘ=−dω_{C}/dx is the optomechanical coupling coefficient,
T is the temperature,
n_{eff} is the effective refractive index of the optical mode, which depends on the refractive index of the disc and the refractive index of its environment,
Q(r)=P_{abs}/V is the heat source,
P_{abs}=κ_{abs} |a|² is the optical power absorbed in the suspended disc-shaped element of volume V,
ξ is a random Langevin force,
ωₛ²=kₛ/mₛ is the angular resonance frequency,
kₛ is the elastic constant of the vibration mode,
mₛ is the associated mass,
and the relative mass mᵣ and the damping ratio γ are defined as follows:

$${m}_{r} = 1 + \frac{\sqrt{\frac{2 μρ}{{ω}_{s}}}}{h {ρ}_{s}} + \frac{2 \sqrt{\frac{2 μρ}{{ω}_{s}}} + ρ h ( \frac{1}{π} ln ( \frac{32 a}{h} ) - \frac{1}{2} {\int }_{0}^{2 ku} {H}_{0} ( x ) dx )}{a {ρ}_{s} ( 1 - \frac{{J}_{0} ( {k}_{s} a ) {J}_{2} ( {k}_{s} a )}{{J}_{1}^{2} ( {k}_{s} a )} )} \qquad ( 4 )$$

$$γ = \frac{\sqrt{2 {μρω}_{s}}}{h ρ} + \frac{\sqrt{2 {μρω}_{s}} + \frac{{ω}_{s} ρ h}{2} {\int }_{0}^{2 ku} {J}_{0} ( x ) dx}{a {ρ}_{s} ( 1 - \frac{{J}_{0} ( {k}_{s} a ) {J}_{2} ( {k}_{s} a )}{{J}_{1}^{2} ( {k}_{s} a )} )} \qquad ( 5 )$$

where μ is the viscosity
ρ and ρs are the density of the liquid and the solid,
k is the vector of propagation of the wave in the liquid, k being equal to ωₛ/c where c is the speed of sound in the liquid,
J0(x) and H0(x) are the Bessel and Struve functions, respectively.

Although only one optomechanical resonator is illustrated in the figures shown, different embodiments of the device may comprise multiple optomechanical resonators.

Thus, the device may comprise at least two optomechanical resonators in the same cell. Said resonators may be arranged in the vicinity of the same optical waveguide and thus provide redundant measurements. Alternatively, the resonators may be arranged in the vicinity of two different waveguides in which different light beams circulate, in order to carry out different measurements simultaneously. In other cases, the resonators may be arranged in the vicinity of the same optical waveguide in which, thanks to multiplexing, two different light beams circulate, in order to excite different optical modes from one resonator to another. The resonators are advantageously identical but may optionally be different.

In other embodiments, the device comprises several cells, each cell comprising at least one optomechanical resonator. Each cell may comprise the same fluid, thereby providing redundant measurements or simultaneously determining different properties of the fluid. Alternatively, each cell comprises a different fluid, so as to perform simultaneous analyses on several different fluids.

### Examples

The device was tested with glycerol (C₃H₈O₃) as the reference fluid.

Tests were then carried out with decan-1-ol (CH₃(CH₂)₈CH₂OH), which has non-Newtonian behavior with frequency-dependent viscosity in the ultra-high frequency (UHF) range.

1. A device for measuring a first property and a second property of a fluid, comprising:
a cell adapted to receive a volume of fluid,
an optical waveguide comprising an input port adapted to be coupled to a light source so as to transmit an optical signal emitted by the light source,
an optomechanical resonator arranged in the cell so as to have at least one main surface in contact with the fluid, the resonator comprising a suspended element arranged in the vicinity of the optical waveguide to allow evanescent coupling between the optical waveguide and the suspended element,
a measuring unit arranged at an output port of the optical waveguide for receiving the output optical signal, comprising:
a first detection unit configured to measure a low frequency component of the output signal, and
a second detection unit for measuring a radiofrequency component of the output signal, and
a processing unit coupled to the measuring unit and configured to:
from measurement data of the first detection unit, determine the first property of the fluid among a refractive index and a thermal conductivity of the fluid, and
from measurement data of the second detection unit, determine the second property of the fluid among a viscosity, a density and a compressibility of the fluid.

2. The device of claim 1, wherein the suspended element is a disc or a ring secured to a substrate defining one face of the cell by a central foot.

3. The device of claim 1, wherein the suspended element has an oblong shape and is secured to a substrate defining one face of the cell by two feet.

4. The device of claim 1, wherein the suspended element is a nanostructured beam secured by its two ends to a substrate defining two faces of the cell.

5. The device of claim 1, wherein the suspended element is made of an optomechanical crystal, in particular silicon.

6. The device of claim 1, wherein the cell has a volume of less than 1 microliter, preferably less than 1 nanoliter.

7. The device of claim 1, wherein the cell has at least one dimension less than 1 mm, preferably less than 200 μm.

8. The device of claim 1, wherein the cell is closed.

9. The device of claim 1, wherein the cell is a microfluidic channel extending between a fluid inlet and a fluid outlet.

10. The device of claim 1, further comprising at least one actuation device adapted to vibrate the suspended element.

11. The device of claim 1, further comprising a heater for controlling the temperature of the fluid in the cell.

12. A method for measuring at least a first property and a second property of a fluid, comprising:
placing the fluid in the cell of a device according to claim 1,
transmitting an optical signal emitted by the light source by the optical waveguide,
exciting at least one optical mode of the optomechanical resonator by the evanescent coupling of the suspended element and the optical waveguide,
oscillating the suspended element according to at least one mechanical resonance mode, said oscillation affecting the signal transmitted by the optical waveguide by the evanescent coupling,
measuring, by the first detection unit, a low-frequency component of the output signal,
measuring, by the second detection unit, a radiofrequency component of the output signal,
from measurement data of the first detection unit, determining the first property among a refractive index and a thermal conductivity of the fluid,
from measurement data of the second detection unit, determining the second property among a viscosity, a density and a compressibility of the fluid.

13. The method of claim 12, wherein the cell is closed and the fluid is static in the cell.

14. The method of claim 12, wherein the cell is a microfluidic channel extending between a fluid inlet and a fluid outlet and the fluid is flowing in the microfluidic channel.

15. The method of claim 12, comprising a power sweep of the light source.

16. The method of claim 12, comprising a wavelength sweep of the light source.

17. The method of claim 12, wherein the device comprises at least one actuation device adapted to vibrate the suspended element, the method further comprising activating the at least one actuation device to vibrate the suspended element, and wherein the detection unit measures a resonance frequency of the suspended element.

18. The method of claim 12, wherein the suspended element is activated in vibration by thermomechanical noise generated by molecules of the fluid, and wherein the detection device measures a resonance frequency of the suspended element.

19. The method of claim 12, comprising simultaneously transmitting, by the optical waveguide, two light beams of different wavelengths, each wavelength being associated with a measurement of a low frequency, respectively radio frequency component, of the output signal, and simultaneously measuring said components by the first and second detection units.
